(19) United States
(12) Patent Application Publication
(10) Pub. No.: US 2025/0174866 A1
(43) Pub. Date: May 29, 2025

(54) FILTER FOR COMMUNICATION DEVICE

(71) Applicant: KMW INC., Hwaseong-si (KR)

(72) Inventors: Joung Hoe KIM, Hwaseong-si (KR); Sang Yoong KIM, Hwaseong-si (KR)

(73) Assignee: KMW INC., Hwaseong-si (KR)

(21) Appl. No.: 19/035,751

(22) Filed: Jan. 23, 2025

Related U.S. Application Data
(63) Continuation of application No. PCT/KR2023/010825, filed on Jul. 26, 2023.

(30) Foreign Application Priority Data
Jul. 27, 2022 (KR) 10-2022-0092885
Jul. 24, 2023 (KR) 10-2023-0096036

(51) Int. Cl. H01P 1/208; H01P 7/10

(52) U.S. Cl. CPC H01P 1/2084; H01P 7/10

(57) ABSTRACT

The present invention relates to a communication device filter. Particularly, the communication device filter comprises: a frequency tuning panel comprising multiple tuning bars disposed in a dielectric material-filled space as a single layer with regard to the thickness direction so as to adjust the distance of spacing from multiple resonators disposed in the dielectric material-filled space; and a resonance substrate disposed in the dielectric material-filled space as a single layer with regard to the thickness direction such that the multiple resonators are formed as the single layer, the resonance substrate comprising a resonance frame having a rectangular edge. Accordingly, the present invention provides advantages in that not only is product slim design possible, but any increase in product weight can be prevented.

### TECHNICAL FIELD

The present disclosure relates to a filter for a communication device, and more particularly, to a filter for a communication device that can be manufactured with a slim thickness while achieving weight reduction.

### BACKGROUND ART

A radio frequency device such as a radio frequency filter (including all ‘communication devices’) is usually composed of a connection structure of a plurality of resonators. Such a resonator is a circuit element that resonates at a specific frequency by a combination of an inductor 1 and a capacitor C in an equivalent electronic circuit, and each resonator has a structure in which a dielectric resonance element (dielectric resonance element (DR)) or a metal resonance element is installed inside a cavity such as a metallic cylinder or rectangular parallelepiped surrounded by a conductor. Accordingly, each resonator has a structure in which only an electromagnetic field of a unique frequency according to a processing frequency band exists in a cavity, thereby enabling high-frequency resonance. Usually, a plurality of resonance stages are formed using a plurality of cavities, and a multi-stage structure in which the plurality of resonance stages are sequentially connected is used.

An example of a radio frequency filter having a plurality of cavity structures is disclosed in Korean Patent Publication No. 10-2004-0100084 (title: “Radio Frequency Filter”, published on Dec. 2, 2004) previously filed by the applicant of the present application.

However, the conventional radio frequency filter is provided so that each resonator extends in a thickness direction within a cavity and a portion of a filter tuning cover covering the cavity is deformed in an engraving manner to have desired bandpass characteristics, thereby tuning the frequency. Therefore, there is a very limited problem in reducing the size of the completed filter in the thickness direction.

In addition, the conventional radio frequency filter is to reinforce skirt characteristics of adjacent resonance periods or spaced resonance periods within a plurality of cavities, and thus require the installation of an additional configuration of a conductive material to implement inductive coupling or capacitive coupling, which also points out the problem that the weight of the completed filter significantly increases.

### DISCLOSURE

### Technical Problem

The present disclosure has been made to solve the above-mentioned technical problem, and an object of the present disclosure is to provide a filter for a communication device including a tuning panel having a plurality of tuning bars disposed as a single layer in a thickness direction within a dielectric material-filled space.

In addition, the present disclosure provides a filter for a communication device capable of performing frequency tuning by adjusting a separation distance between a plurality of resonators of a resonance substrate disposed as a single layer different from a tuning panel in a thickness direction within a dielectric material-filled space.

In addition, the present disclosure provides a filter for a communication device including a notch forming part formed as a single layer identical to a tuning panel.

However, the technical problems of the present disclosure are not limited to the problems mentioned above, and other technical problems not mentioned will be clearly understood by those skilled in the art from the following description.

### Technical Solution

In one general aspect, a filter for a communication device includes a frequency tuning panel which includes a plurality of tuning bars disposed as a single layer in a thickness direction within a dielectric material-filled space to adjust a separation distance between a plurality of resonators disposed within the dielectric material-filled space.

The dielectric material-filled space may be a closed space having a thickness smaller than a length direction and a width direction.

The frequency tuning panel may include a tuning frame having a rectangular edge and the plurality of tuning bars extending from an inner side of one long side to the other long side among four sides of the tuning frame.

The plurality of tuning bars may be formed integrally with the tuning frame.

The plurality of tuning bars may be disposed to be spaced apart from each other by a predetermined distance in a length direction.

The plurality of tuning bars may be disposed to be spaced apart from each other in a length direction at positions that match each of the plurality of resonators disposed to be spaced apart from each other in the thickness direction within the dielectric material-filled space.

Each of the plurality of tuning bars may have different lengths extending to the other long side.

The frequency tuning panel may further include a notch forming part that extends to protrude from an inner side of the other long side to the one long side among the four sides of the tuning frame while forming a closed loop, or extends to be connected to the inner side of the one long side without forming the closed loop.

The notch forming part may include an L-notch part forming the closed loop and a C-notch part not forming the closed loop.

The L-notch part may implement cross coupling through magnetic field properties between any three adjacent resonators within the dielectric material-filled space.

The C-notch part may implement cross coupling through electric field properties between any three adjacent resonators within the dielectric material-filled space.

The filter may further include a resonance substrate that includes a resonance frame disposed as a single layer in the thickness direction within the dielectric material-filled space and has a rectangular edge, wherein the plurality of resonators are formed as the single layer.

The plurality of resonators may be formed to extend from one long side to the other long side among the four sides of the resonance frame by a predetermined length, and disposed to overlap the plurality of tuning bars by at least a predetermined length in the thickness direction.

The plurality of resonators may extend to be spaced apart from the other long side.

The filter may further include a spacer panel that is disposed to be stacked in the thickness direction within the dielectric material-filled space between the frequency tuning panel and the resonance substrate to block direct contact between the frequency tuning panel and the resonance substrate.

The spacer panel may be formed to correspond to shapes of the edges of the tuning frame of the frequency tuning panel and the resonance frame of the resonance substrate.

The frequency tuning panel may include a tuning frame having a thickness greater than the plurality of tuning bars, and the resonance substrate may include a resonance frame having a thickness greater than the plurality of resonators.

The filter may further include a filter body that is formed to be opened on one side of the dielectric material-filled space in the thickness direction, forms a portion of the dielectric material-filled space, and has an installation space having the resonance substrate and the frequency tuning panel stacked therein and a filter tuning cover that forms the rest of the dielectric material-filled space while covering the opened one side of the filter body in the thickness direction.

A plurality of space dividing ribs may be integrally formed on an inner side surface of the filter body in the thickness direction to divide a portion of the dielectric material-filled space and protrude to partition between the plurality of resonators of the resonance substrate.

The filter tuning cover may be formed with a plurality of tuning holes to push the plurality of tuning bars using a predetermined tool.

The filter tuning cover may be formed with a plurality of coupling control bars cut to change a coupling value between adjacent resonators among the plurality of resonators by changing its shape toward the dielectric material-filled space.

The plurality of coupling control bars may be alternately disposed with the plurality of resonators in the thickness direction of the dielectric material-filled space.

### Advantageous Effects

According to a filter for a communication device according to an embodiment of the present disclosure, the following various effects can be achieved.

First, since a plurality of resonators of a resonance substrate and a plurality of tuning bars of a frequency tuning panel are respectively disposed as different single layers within a dielectric material-filled space, it has the effect of facilitating slim manufacturing design of a product.

Second, since a notch forming part is provided to form the same single layer as a plurality of tuning bars of a frequency tuning panel or the same single layer as a resonator of a resonance substrate, it does not require additional parts for skirt characteristics, thereby preventing an increase in the weight of the product, and thus facilitating a lightweight design.

### BRIEF DESCRIPTION OF THE DRAWINGS

FIG. 1 is a perspective view illustrating a filter for a communication device according to a first embodiment of the present disclosure,

FIGS. 2A and 2B are exploded perspective views of FIG. 1.

FIG. 3 is an exploded perspective view illustrating a resonator of a resonance substrate and a tuning bar of a frequency tuning panel in the configuration of FIG. 1 and an enlarged view of a portion thereof.

FIG. 4 is a partial cut-away perspective view illustrating an inside of a dielectric material-filled space in the configuration of FIG. 1.

FIG. 5 is a perspective view illustrating a filter for a communication device according to a second embodiment of the present disclosure.

FIGS. 6A and 6B are exploded perspective views of FIG. 5.

FIG. 7 is a perspective view illustrating a filter for a communication device according to a third embodiment of the present disclosure.

FIGS. 8A and 8B are exploded perspective views of FIG. 7.

FIG. 9 is a partial cut-away perspective view illustrating an inside of a dielectric material-filled space in the configuration of FIG. 7.

FIG. 10 is a perspective view illustrating a filter for a communication device according to a fourth embodiment of the present disclosure.

FIGS. 11A and 11B are exploded perspective views of FIG. 10.

### DESCRIPTION OF REFERENCE SIGNS

1,100,200,300: Filter 10,110,210,310: Filter body
20,120,220,320: Filter tuning cover 21,121,221,321: Tuning correction hole
30,230: Resonance substrate 31,131,231,331: Resonator
40,140,240,340: Frequency tuning pane 141,141,241,341: Tuning
50: Spacer panel 122,222,322: Coupling control bar

### BEST MODE

Hereinafter, a filter for a communication device according to embodiments of the present disclosure will be described in detail with reference to the attached drawings.

It is to be noted that in giving reference numerals to components of each of the accompanying drawings, the same components will be denoted by the same reference numerals even though they are illustrated in different drawings. Further, in describing exemplary embodiments of the present disclosure, well-known constructions or functions will not be described in detail in the case in which it is decided that they may unnecessarily obscure the understanding of exemplary embodiments of the present disclosure.

Terms ‘first’, ‘second’, A, B, (a), (b), and the like, will be used in describing components of exemplary embodiments of the present disclosure. These terms are used only in order to distinguish any component from other components, and features, sequences, or the like, of corresponding components are not limited by these terms. In addition, unless defined otherwise, all the terms used in the present specification, including technical and scientific terms, have the same meanings as meanings that are generally understood by those skilled in the art to which the present disclosure pertains. It should be interpreted that terms defined by a generally used dictionary are identical with the meanings within the context of the related art, and they should not be ideally or excessively formally interpreted unless the context clearly dictates otherwise.

Filters 1, 100, 200, and 300 for a communication device according to embodiments of the present disclosure include filter bodies 10, 110, 210, and 310, and filter tuning covers 20, 120, 220, and 320 coupled to the filter bodies 10, 110, 210, and 310 to form dielectric material-filled spaces 10S, 110S, 210S, and 310S between the filter bodies 10, 110, 210, and 310.

In the dielectric material-filled space 10S, 110S, 210S, and 310S, a dielectric having a predetermined permittivity is filled. However, in the embodiments of the present disclosure, since air also corresponds to a dielectric material having a predetermined permittivity, it will be described assuming that the dielectric material-filled space 10S, 110S, 210S, and 310S is filled with air as a dielectric. In this way, when air is adopted as a dielectric, it means that the dielectric material-filled space 10S, 110S, 210S, and 310S, which is an empty space, is naturally filled with air as a dielectric unless the dielectric material-filled space 10S, 110S, 210S, and 310S is in a sealed vacuum state, without a separate dielectric filling process.

Hereinafter, a filter for a communication device according to the present disclosure will be described in detail in order for each embodiment.

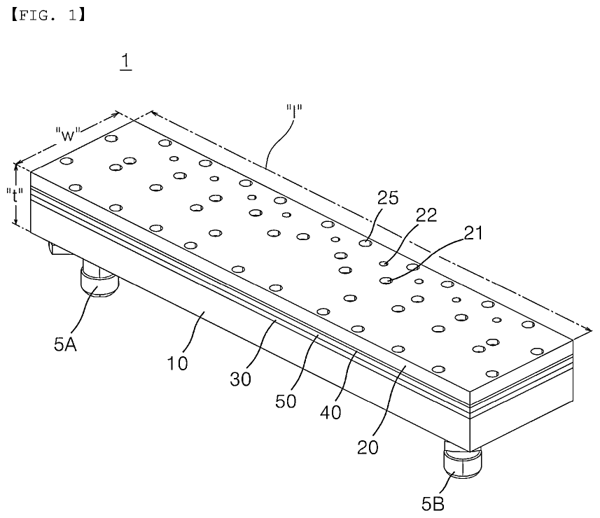

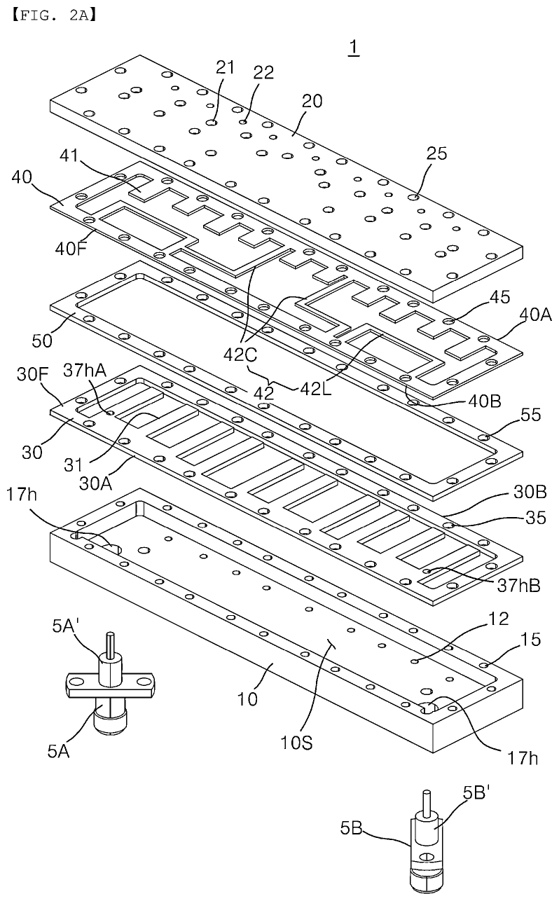

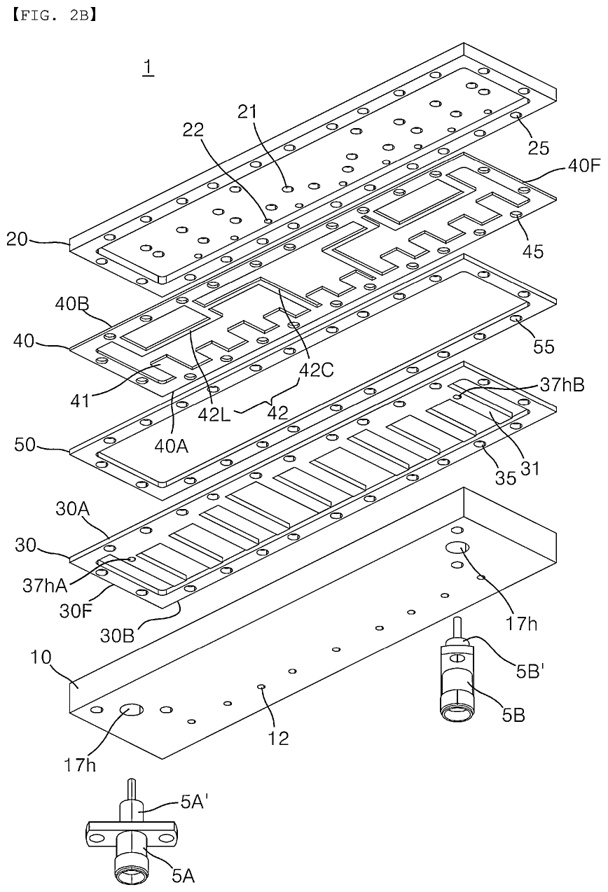

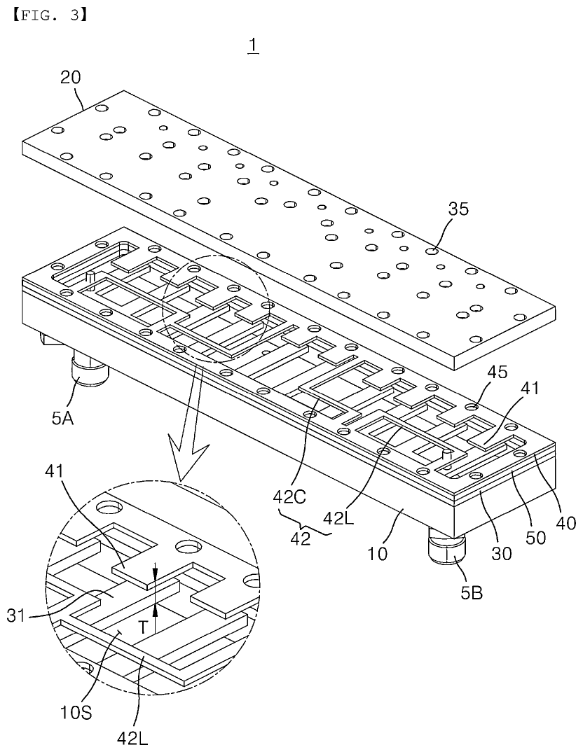

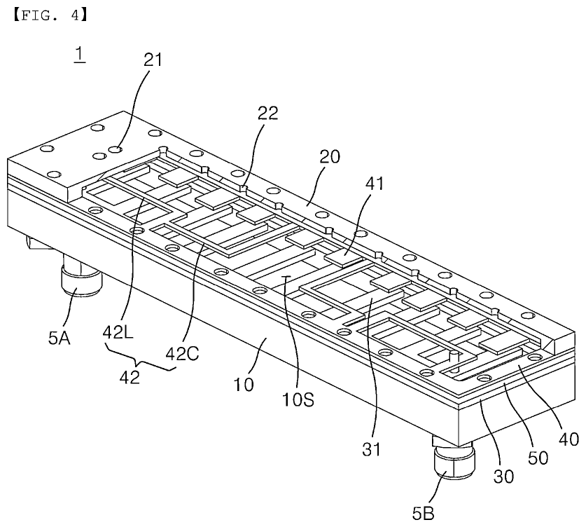

FIG. 1 is a perspective view illustrating a filter for a communication device according to a first embodiment of the present disclosure, FIGS. 2A and 2B are exploded perspective views of FIG. 1, FIG. 3 is an exploded perspective view and an enlarged view of a portion thereof illustrating a resonator of a resonance substrate and a tuning bar of a frequency tuning panel among the components of FIG. 1, and FIG. 4 is a partial cut-away perspective view illustrating the inside of a dielectric material-filled space among the components of FIG. 1.

Referring to FIGS. 1 to 4, a filter 1 for a communication device according to a first embodiment of the present disclosure may include, a filter body 10, a filter tuning cover 20 coupled to form the dielectric material-filled space 10S between the filter body 10, a resonance substrate 30 including the plurality of resonators 31 disposed to form a single layer in the thickness direction within the dielectric material-filled space 10S, and a frequency tuning panel 40 including a plurality of tuning bars 41 disposed to form a single layer in the thickness direction within the dielectric material-filled space 10S.

Referring to FIGS. 2A and 2B, the filter body 10 may be formed in a slim rectangular shape to form the closed dielectric material-filled space 10S having a thickness t that is approximately smaller than a length 1 and a width w.

Here, some of the dielectric material-filled space 10S may be formed by an open one side space of the filter body 10, and the rest of the dielectric material-filled space 10S may be formed by the other side space of the filter tuning cover 20.

To form the dielectric material-filled space 10S, the filter body 10 is provided in a form in which one side to which the filter tuning cover 20 is coupled collapses to a predetermined depth in a direction (downward in the drawing) toward the other side surface, and an inner side surface of the filter tuning cover 20 may also be provided in a form in which it collapses to a predetermined depth in the opposite direction (upward in the drawing).

The inside of the dielectric material-filled space 10S may be filled with a dielectric having a predetermined permittivity, but as described above, since air is also a type of dielectric having a predetermined permittivity, the first embodiment (the second to fourth embodiments described below are all the same) of the present disclosure is described assuming that a dielectric called air is filled.

Meanwhile, in the filter body 10, an input port hole 17h and an output port hole 17h, to which an input port 5A and an output port 5B for inputting a predetermined signal to one side of the resonance substrate 30 described later are fixed, may be through-formed to communicate with the dielectric material-filled space 10S.

Here, the input port 5A and the output port 5B may be electrically connected to a port connecting holes 37hA and 37hB of the resonance substrate 30, respectively, via an input coaxial connector 5A′ and an output coaxial connector 5B′ so that impedance matching is maintained. However, the electrical connection with the resonance substrate 30 is not necessarily limited to the method using the input port 5A and the input coaxial connector 5A′ and the output port 5B and the output coaxial connector 5B′, and when it is a conductive medium equipped on the main board (not illustrated), an electrical connection by any structure of electrical connection configuration such as a pin is possible.

The resonance substrate 30 is disposed as a single layer in the thickness direction t within the dielectric material-filled space 10S, and the plurality of resonators 31 are also formed as a single layer, and may include a resonance frame 30F having a rectangular edge.

Here, the resonance frame 30F may be formed to have edge portions that roughly matches end portions of an edge of the filter body 10 and the filter tuning cover 20.

Hereinafter, for the convenience of understanding, the resonance frame 30F is formed to communicate in the vertical direction by cutting the middle in a rectangular shape, and will be described assuming that it is formed in a rectangular shape extending from the left to the right in the drawings of FIGS. 2A and 2B. Since a left end and a right end in a length direction have relatively short sides, they are referred to as ‘short sides’, and since a front end and a rear end in a width direction have relatively long sides, they are referred to as ‘long sides’.

Here, referring to FIGS. 2A and 2B, the plurality of resonators 31 may be formed to extend by a predetermined length from any one long side 30A to the other long side 30B among four sides of the resonance frame 30F.

However, it is preferable that the plurality of resonators 31 are formed to be spaced apart from each other so that their leading ends are not connected to an inner side end of an edge of the other long side 30B described above.

In addition, the plurality of resonators 31 may be formed so that their leading ends have the same separation distance from the inner side end of the edge of the other long side 30B. However, extension starting points of each of the plurality of resonators 31 do not have to be the same, and the extension starting points may be designed differently based on the frequency band pass characteristics required by the designer. That is, the extension starting points of each of the plurality of resonators 31 corresponds to the inner side end of the edge of any one long side 30A described above, and may be formed in a form that extends from the inner side end of the edge of the long side 30A to each extension starting point of the adjacent resonators 31.

Meanwhile, as illustrated in FIGS. 2A and 2B, the frequency tuning panel 40 may be disposed as a single layer between the resonance substrate 30 and the filter tuning cover 20.

More specifically, the frequency tuning panel 40 may include a tuning frame 40F having rectangular edges, and a plurality of tuning bars 41 extending from an inner side of one long side 40A to the other long side 40B side among the four sides of the tuning frame 40F.

Here, the plurality of tuning bars 41 may be formed integrally with the tuning frame 40F. Preferably, the plurality of tuning bars 41 may be formed to extend integrally from the inner side of one long side 40A of the tuning frame 40F, but may be formed to extend by a predetermined length so as to form the same single layer in the thickness direction t of the dielectric material-filled space 10S.

Such a frequency tuning panel 40 may be disposed in a single layer different from the plurality of resonators 31 in the thickness direction t within the dielectric material-filled space 10S so as to adjust the separation distance (see ‘T’ of FIG. 3) of the plurality of tuning bars 41 from the plurality of resonators 31 disposed within the dielectric material-filled space 10S.

Here, the plurality of tuning bars 41 may be provided to be spaced apart from each other by a predetermined distance in the length direction I along an edge surface of the inside side of one long side 40A of the tuning frame 40F, and each tuning bar 41 may be disposed to be spaced apart from each other in the length direction I at positions matching each of the plurality of resonators 31 disposed to be spaced apart from each other in the thickness direction t within the dielectric material-filled space 10S.

Meanwhile, the plurality of tuning bars 41 may be set such that, unlike the above-described plurality of resonators 31 whose extension starting points are different, the extension starting points of the inner side of one long side 40A of the tuning frame 40F may all be set to the edge end of the inner side of the one long side 40A of the tuning frame 40F which is on the same line.

In addition, the leading ends of the plurality of tuning bars 41 may be set such that the leading ends of the above-described plurality of resonators 31 are extended to have the same separation distance as the inner side end of the edge of the other long side 30B of the resonator frame 30F, but the lengths extending toward the other long side 40B each are the same or different.

However, in this case, since the plurality of tuning bars 41 are configured to perform fine frequency tuning by adjusting the separation distance T with the plurality of resonators 31 disposed in different single layers in the dielectric material-filled space 10S, it is preferable that the plurality of resonators 31 or the plurality of tuning bars 41 be designed to be disposed to overlap by at least a predetermined length in the thickness direction t of the dielectric material-filled space 10S.

In this case, when it is assumed that the dielectric filled in the dielectric material-filled space 10S is air, an air layer may exist between the plurality of resonators 31 of the resonance substrate 30 and an air layer with the same permittivity may also exist between the multiple resonators 31 and the inner surface of the filter body 10, and the fine frequency tuning may be performed through a slight change in the air layer according to the amount of shape deformation of each of the tuning bars 41 of the frequency tuning panel 40.

Meanwhile, in the filter 1 for a communication device according to the first embodiment of the present disclosure, as illustrated in FIGS. 2A and 2B, the frequency tuning panel 40 may further include a notch forming part 42 including an L-notch part 42L that protrudes and extends from the inner side of the other long side 40B to the one long side 40A among the four sides of the tuning frame 40F while forming the closed loop and a C-notch part 42C that extends so as to be connected to the inner side of one long side 40A without forming a closed loop.

Here, the L-notch part 42L serves to form an L-notch according to inductive coupling at a right end of the passband by reinforcing the skirt characteristics, and the C-notch part 42C serves to form a C-notch according to capacitive coupling at a left end of the passband by reinforcing the skirt characteristics.

The L-notch part 42L may be provided to extend from the inner side of the other long side 40B of the frequency tuning panel 40 to form a single layer identical to the tuning bar 41 described above while simultaneously forming the closed loop that does not contact one long side 40A.

In addition, the C-notch part 42C may be provided to extend from the inner side of the other long side 40B of the frequency tuning panel 40 or the L-notch part 42L described above to be connected to one long side 40A while forming the single layer identical to the tuning bars 41 described above.

Here, the C-notch part 42C has a difference in that, unlike the L-notch part 42L, it does not form a closed loop with respect to the other long side 40B within the same single layer.

The C-notch part 42C and the L-notch part 42L form an electric field (E-field) or a magnetic field (H-field) between the plurality of resonators 31 provided within the single layer, each having the same shape and the same shape of the corner or folded portion, thereby forming the C-notch or L-notch described above on the left or right side of the passband.

Meanwhile, referring to FIG. 2A and FIG. 2B, the C-notch part 42C among the C-notch part 42C and the L-notch part 42L may be formed by extending from the inner side end of the edge of the other long side 40B of the frequency tuning panel 40, and may also be formed by extending from a portion of the previously formed L-notch part 42L.

Meanwhile, as described above, since the resonator 31 of the resonance substrate 30 and the tuning bar 41 of the frequency tuning panel 40 perform the fine frequency tuning by adjusting the separation distance in the thickness direction t, the structural design is required to secure a minimum separation distance.

To this end, the filter 1 for a communication device according to the first embodiment of the present disclosure may further include a spacer panel 50 that is disposed to be stacked in the thickness direction t in the dielectric material-filled space 10S between the resonance substrate 30 and the frequency tuning panel 40 to block the direct contact between the frequency tuning panel 40 and the resonance substrate 30.

Here, blocking the direct contact between the frequency tuning panel 40 and the resonance substrate 30 by the spacer panel 50 means avoidance of physical space contact that forms the thickness to secure the separation distance, and does not mean blocking of electrical connection.

The spacer panel 50 may be formed to correspond to the shape of the frame of the tuning frame 40F of the frequency tuning panel 40 and the resonance frame 30F of the resonance substrate 30.

Such a spacer panel 50 performs a role of securing the above-described separation distance so that a desired passband frequency may be tuned by finely adjusting the separation distance T in the air layer that exists between the resonators 31 of the resonance substrate 30 and the tuning bars 41 of the frequency tuning panel 40.

However, the spacer panel 50 does not necessarily have to be manufactured separately and stacked between the resonance substrate 30 and the frequency tuning panel 40. The spacer panel 50 can be formed integrally so as to have different thicknesses on an upper surface portion of the edge of the resonance substrate 30, or conversely, can be formed integrally so as to have different thicknesses on a lower surface portion of the edge of the frequency tuning panel 40. It is sufficient to ensure the above-described separation distance by integrally forming and stacking the upper surface part of the edge of the resistance substrate 30 and the lower surface part of the frequency tuning panel 40 so as to be half different from the thickness of the spacer panel 50.

That is, the tuning frame 40F of the frequency tuning panel 40 may be formed to have a thickness greater than the plurality of tuning bars 41, and the resonance frame 30F of the resonance substrate 30 may be formed to have a thickness greater than the plurality of resonators 31. In this case, the surface where the tuning frame 40F and the plurality of tuning bars 41 are matched is disposed at the upper portion in the drawing, and the surface where the resonance frame 30F and the plurality of resonators 31 are matched is disposed at the lower portion in the drawing, so that the plurality of tuning bars 41 and the plurality of resonators 31 may be additionally secured by the distance separated by the spacer panel 50 described above. In addition, referring to FIGS. 1 to 4, the dielectric material-filled space 10S corresponding to a gap between the filter body 10 and the filter tuning cover 20 is filled with a dielectric defined as air, and the tuning designer may perform the fine frequency tuning operation of inserting a predetermined tuning tool (not illustrated) into the inner side of the dielectric material-filled space 10S through the lower portion of the filter body 10 or the upper portion of the filter tuning cover 20, and then pushing the leading end of the resonators 31 to change its shape in the thickness direction t toward the tuning bar 41 or changes the shape of the leading end of the tuning bars 41 in the thickness direction t toward the resonators 31.

Here, a plurality of bottom tuning holes 12 for inserting the above-described tuning tool may be formed on the lower surface of the filter body 10 so as to be in communication with the dielectric material-filled space 10S, and a plurality of upper tuning holes 22 for inserting the above-described tuning tool may be formed on the upper surface of the filter tuning cover 20 so as to be in communication with the dielectric material-filled space 10S.

However, it is not necessary to have both the bottom tuning hole 12 and the upper tuning hole 22 in the filter body 10 and the filter tuning cover 20, and one of the two can be provided so as to function as a tuning hole into which the original tuning tool is inserted, and the other can be provided so as to function as a tuning correction hole for correction after tuning.

In addition, it is also possible that the filter body 10 is not provided with the bottom tuning hole 12, and only the filter tuning cover 20 is provided with the upper tuning hole 22 and the tuning correction hole 21. The tuning correction hole 21 may be a hole provided to readjust the deformed tuning bar 41 by inserting a separate tuning correction tool (not illustrated) when the correction is required after performing the fine frequency tuning using the tuning tool.

In the filter for a communication device according to the first embodiment of the present disclosure having such a configuration, the filter body 10, the resonance substrate 30, the spacer panel 50, the frequency tuning panel 40, and the filter tuning cover 20 are sequentially stacked and disposed, and the dielectric material-filled space 10S may be coupled to be closed by using a coupling screw (not illustrated) that penetrates and is fastened through a plurality of stacked coupling screw holes 15, 35, 55, 45, and 25 provided in each edge portion.

Here, the filter body 10, the resonance substrate 30, the spacer panel 50, the frequency tuning panel 40, and the filter tuning cover 20 may all be formed of a metal material, or formed of a predetermined dielectric material, and then formed so that the exposed portion toward the dielectric material-filled space 10S is entirely coated with a metal material. As long as the portion exposed toward the dielectric material-filled space 10S is coated with the metal material to form the dielectric material-filled space 10S as the closed space, the stacked coupling method of the remaining components (resonance substrate 30, spacer panel 50, frequency tuning panel 40, and filter tuning cover 20) for the filter body 10 need not be a screw coupling method, and various coupling methods including a welding coupling method and an adhesive coupling method may be applied.

The filter 1 for a communication device according to the first embodiment of the present disclosure configured as described above will describe a specific passband frequency filtering process with reference to FIGS. 3 and 4 as follows.

First, when a predetermined signal is input to the dielectric material-filled space 10S through the input port 5A on one side, it is sequentially transmitted in the length direction I through the resonator 31 of the resonance substrate 30 connected through the input coaxial connector 5A′ of the input port 5A in the dielectric material-filled space 10S, and is output through the resonator 31 of the resonance substrate 30 connected to the output coaxial connector 5B′ of the output port 5B in the dielectric material-filled space 10S.

In this case, only a specific bandpass frequency may be output according to the fine frequency tuning by the detailed design of the separation distance T in the upper and lower thickness direction t of each resonator 31 and the tuning bar 41.

Here, according to the filter 1 for a communication device according to the first embodiment of the present disclosure, the extension formation direction of the resonator 31 is provided to form the single layer in the thickness direction t within the dielectric material-filled space 10S, and the tuning bar 41 is also provided to form the single layer in the thickness direction t different from that of the resonator 31 within the dielectric material-filled space 10S, thereby enabling slim manufacturing of the overall product thickness and providing the advantage of enabling the fine frequency tuning within the distance limit of each single layer in the different thickness directions t described above.

Hereinafter, the filter 1 for a communication device according to the second to fourth embodiments, which are implemented as different embodiments from the filter 1 for a communication device according to the first embodiment described above, will be described in order. However, the overlapping configuration with the first embodiment 1 will be replaced with the already described contents, and different parts from the first embodiment 1 will be mainly described for each embodiment 100, 200, and 300.

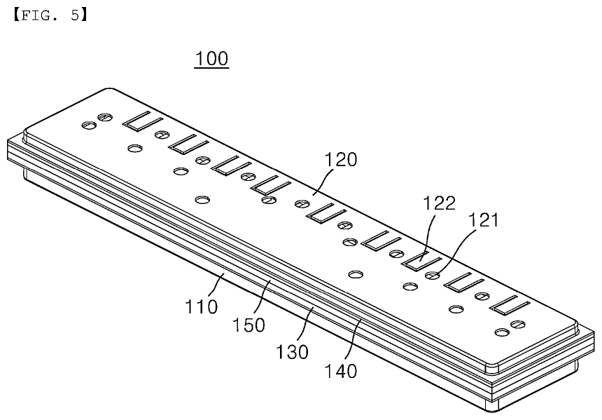

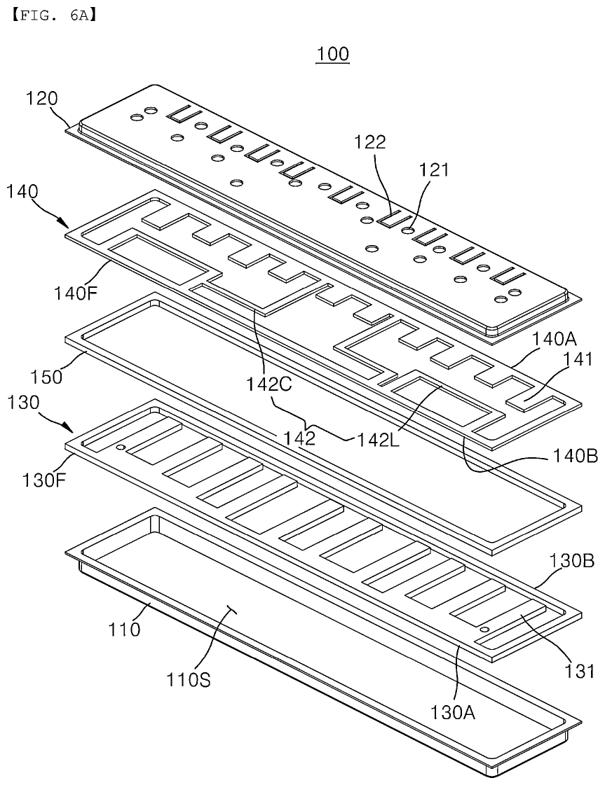

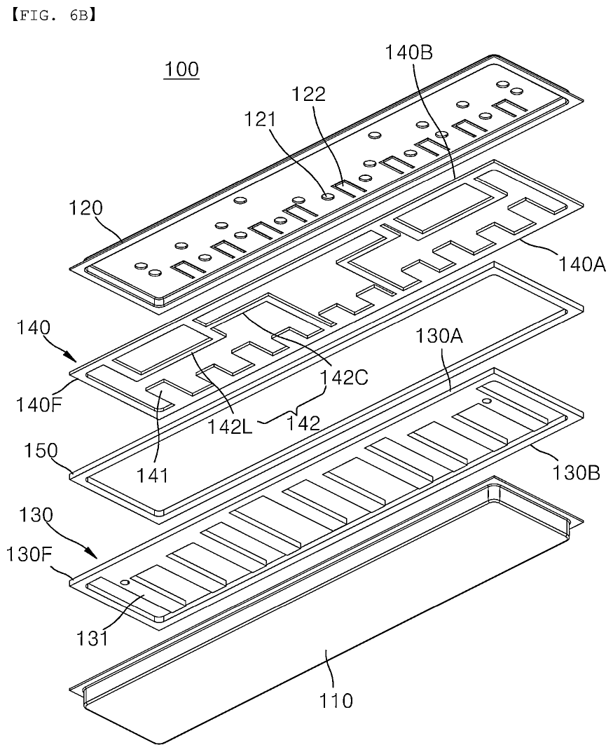

FIG. 5 is a perspective view illustrating a filter for a communication device according to the second embodiment of the present disclosure, and FIGS. 6A and 6B are exploded perspective views of FIG. 5.

According to the second embodiment of the present disclosure, referring to FIGS. 5 to 6B, the filter 1 for a communication device may have a plurality of coupling control bars 122 cut and formed in a filter tuning cover 120, which change a coupling value between adjacent resonators 131 among the plurality of resonators by changing the shape toward the dielectric material-filled space 110S.

More specifically, the plurality of coupling control bars 122 may each be formed to be alternately disposed with respect to the plurality of resonators 131 in the thickness direction t of the dielectric material-filled space 110S.

Here, each of the plurality of coupling control bars 122 may have one side integrally connected to the filter tuning cover 120, and the remaining portions other than the portion integrally connected to the filter tuning cover 120, may be cut and formed in a ‘⊏’ shape.

When a tuning worker (designer) pushes the leading end of one of the plurality of coupling control bars 122 toward the dielectric material-filled space 110S using the predetermined tool so that the coupling value desired by the tuning worker is implemented between adjacent resonators 131 among the plurality of resonators 131, the leading end of the coupling control bar 122 is positioned between the adjacent resonators 131 by deforming its shape, and in addition to the design value according to the specific shape of the C-notch part 142C or L-notch part 142L described above, the coupling value can be implemented according to the design value desired by the tuning worker according to each shape deformation of the coupling control bar 122.

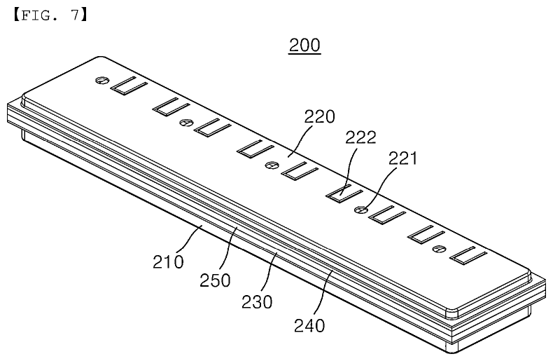

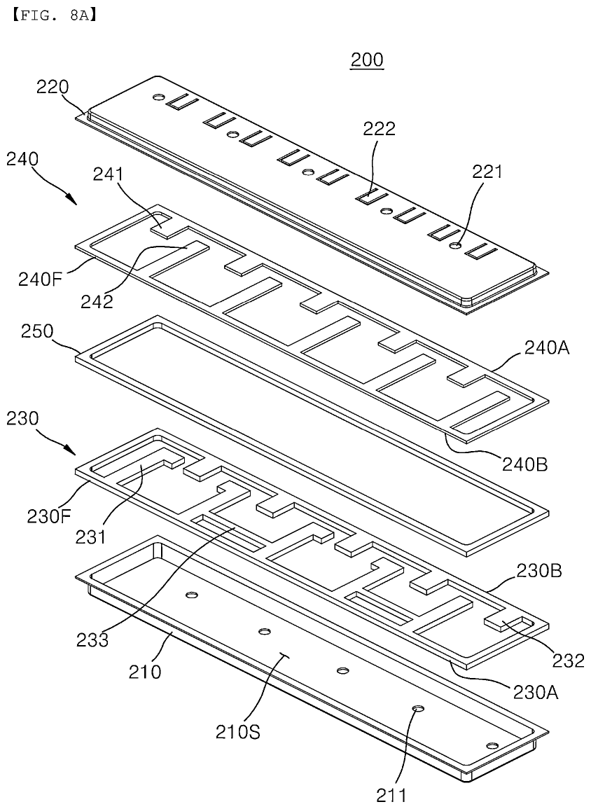

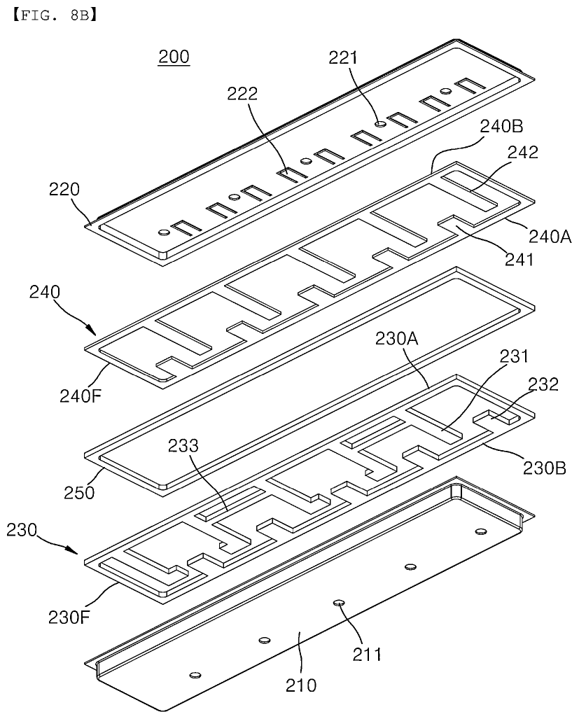

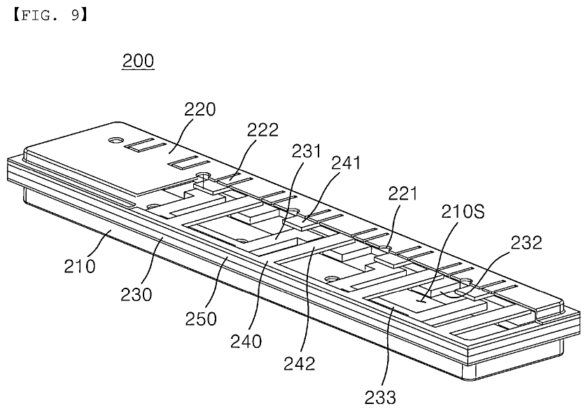

FIG. 7 is a perspective view illustrating a filter for a communication device according to a third embodiment of the present disclosure, FIGS. 8A and 8B are exploded perspective views of FIG. 7, and FIG. 9 is a partial cut-away perspective view illustrating the inside of the dielectric material-filled space among the components of FIG. 7.

In the filter 1 for a communication device according to the first embodiment of the present disclosure described above with reference to FIGS. 1 to 4, the resonator 31 of the resonance substrate 30 and the tuning bar 41 of the frequency tuning panel 40 are formed to extend in the same direction (e.g., from one long side 30A and 40A to the other long sides 30B and 40B), but this is not necessarily limited thereto.

That is, referring to FIGS. 8A and 8B, in the filter 200 for a communication device according to the third embodiment, when a resonance frame 230F of a resonance substrate 230 has a rectangular horizontal cross-section, one 231 of the resonators 231 and 232 of the resonance substrate 230 may be formed to extend from one long side 230A to the other long side 230B by a predetermined length, and the other 232 of the resonators 231 and 232 of the resonance substrate 230 may be formed to extend from the other long side 230B to one long side 230A by a predetermined length.

Here, among the plurality of resonators 231 and 232, the adjacent resonators 231 and 232 may be formed to intersect in a zigzag direction so that the mutual extension directions do not overlap in the length direction I of the resonance substrate 230 while having a length that overlaps by a predetermined length in the width direction w of the resonance substrate 230.

In addition, when a tuning frame 240F of a frequency tuning panel 240 has a rectangular horizontal cross-section, one 241 of tuning bars 241 and 242 of the frequency tuning panel 240 may be formed to extend by a predetermined length from the one long side 240A to the other long side 240B, and the other 242 of the tuning bars 241 and 242 of the frequency tuning panel 240 may be formed to extend by a predetermined length from the other long side 240B to one long side 240A.

In addition, among the plurality of tuning bars 241 and 242, the adjacent tuning bars 241 and 242 may be formed to intersect in a zigzag direction so that the mutual extension directions do not overlap in the length direction l of the frequency tuning panel 240 while having a length that overlaps by a predetermined length in the width direction w of the frequency tuning panel 240.

In this case, it is sufficient if some of the resonators 231 and 232 of the resonance substrate 230 and the tuning bars 241 and 242 of the frequency tuning panel 240 are formed to overlap in the thickness direction t, and by physically dividing one dielectric material-filled space 210S by the resonators 231 and 232 and the tuning bars 241 and 242 extending in opposite directions, the effect of having a plurality of cavities may be provided.

In addition, the filter 200 for a communication device according to the third embodiment may be provided such that, as referenced in FIGS. 8A and 8B, the notch forming part 233 is formed to interconnect adjacent resonators 231 among the resonators formed by extending from one long side 230A of the resonance frame 230F to the other long side 230B. Here, the notch forming part 233 may serve as an L-notch part that forms an L-notch according to inductive coupling at the right end of the passband by reinforcing the skirt characteristics.

The third embodiment 200 in which the notch forming part 233 is formed in the resistance substrate 230, is different from the first embodiment 1 in which the frequency tuning panel 40 is provided to form the same single layer as the tuning bar 41.

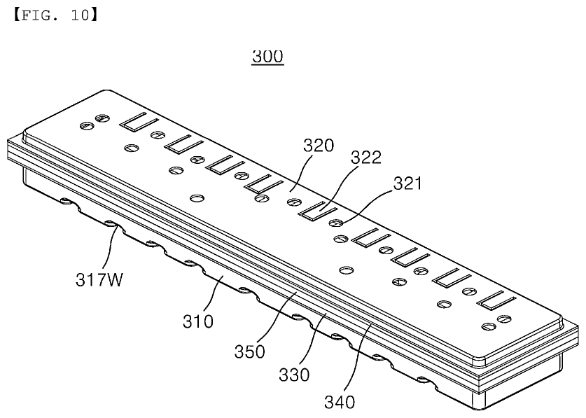

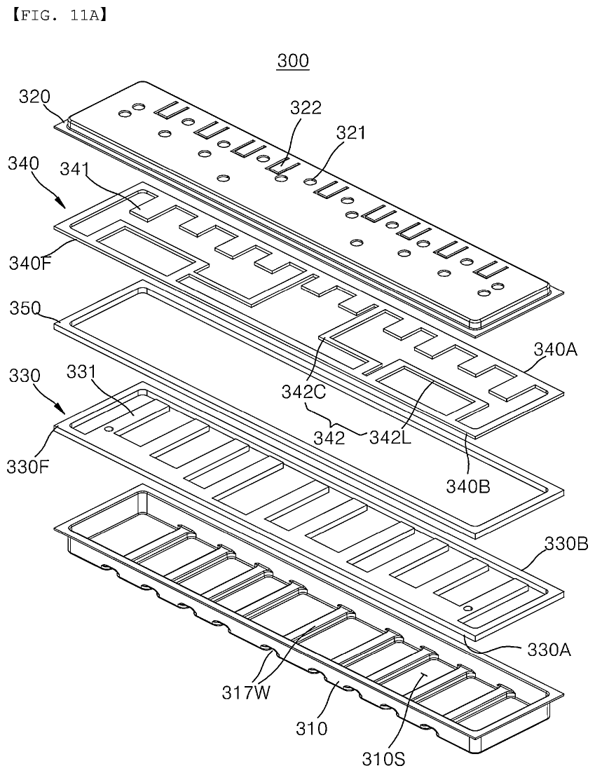

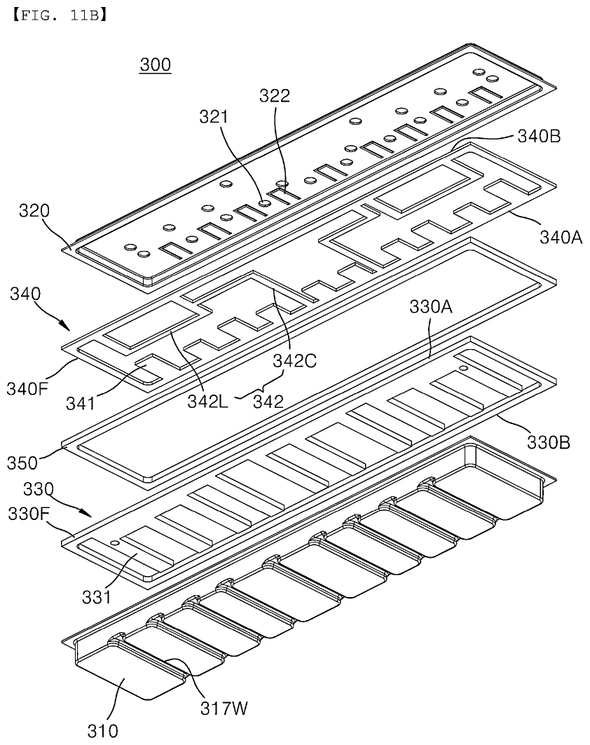

FIG. 10 is a perspective view illustrating a filter for a communication device according to the fourth embodiment of the present disclosure, and FIGS. 11A and 11B are exploded perspective views of FIG. 10.

Referring to FIGS. 10 to 11B, a filter 300 for a communication device according to the fourth embodiment of the present disclosure may further include a plurality of space dividing ribs 317W that do not completely divide the dielectric material-filled space 310S, but at least partially divide a bottom portion of the dielectric material-filled space 310S formed by the filter body 310.

The plurality of space dividing ribs 317W may be formed to extend from the bottom surface of one long side to the bottom surface of the other long side so as to divide the bottom surface portion of the inner side of the filter body 310 formed in the length direction I into a plurality of surfaces, but may be formed in the form of ribs protruding by a predetermined length from at least the bottom surface of the dielectric material-filled space 310S toward the filter tuning cover 320.

The plurality of space dividing ribs 317W occupy a part of the dielectric material-filled space 310S and divide at least the space between the resonators 331 into cavities, thereby providing an advantage of tuning various passband frequencies by controlling the amount of coupling between adjacent resonators 331 according to the size or shape of the occupied space.

In addition, the filter body 310 may be coupled so that the entire bottom surface is soldered to the main board side (not illustrated), and as the plurality of space dividing ribs 317W divide the bottom surface of the filter body 310 in the length direction I, it may also play a role in dispersing and relieving thermal stress caused by a difference in thermal expansion coefficient with the main board, which is a PCB material.

It is described above that, referring to FIGS. 1 to 11B, the filters 1, 100, 200, and 300 for a communication device according to embodiments of the present disclosure may include L-notch parts 42L, 142L, 233, and 343L for implementing inductive coupling, and C-notch parts 42C, 142C, and 343C for implementing capacitive coupling, by utilizing electric and magnetic field properties between the resonators 31, 131, 231, and 331 provided within the dielectric material-filled spaces 10S, 110S, 210S, and 310S.

The inductive coupling is a type of coupling that utilizes the magnetic field properties around the resonators 31, 131, 231, and 331 provided in the dielectric material-filled spaces 10S, 110S, 210S, and 310S, and is a coupling formed naturally between adjacent resonators 31, 131, 231, and 331 unless there are structures that affect magnetic field properties. In particular, when implementing cross coupling by skipping a resonator provided in the middle among any three resonators 31, 131, 231, and 331, the meaning of providing the above-described L-notch parts 42L, 142L, 233, and 343L may be greater. Here, in the case of the filters 1, 100, 200, and 300 for a communication device according to embodiments of the present disclosure, the L-notch part 42L, 142L, 233, and 343L are provided so as not to block a signal transmission path between the leading ends of the adjacent resonators 31, 131, 231, and 331, but may be provided in a form in which they are closer than the resonator provided in the middle among any three resonators 31, 131, 231, and 331 (see 1 in the first embodiment 1, 100 in the second embodiment, and 300 in the fourth embodiment) or in a form in which the resonators on both sides excluding the resonator provided in the middle are directly connected (see 200 in the third embodiment).

Meanwhile, the capacitive coupling is a type of coupling that utilizes electric field properties around the resonators 31, 131, 231, and 331 provided in the dielectric material-filled spaces 10S, 110S, 210S, and 310S, and may be implemented by a structure disposed on the signal transmission path corresponding to the electric fields of adjacent resonators 31, 131, 231, and 331.

More specifically, the C-notch parts 42C, 142C, and 342C implemented through the first, second, and fourth embodiments are formed to extend from the other long sides 40B, 140B, and 340B to one long side 40A, 140A, and 340A of the frequency tuning panels 40, 140, and 340, and are formed to be involved in any three resonators 31, 131, and 331 of the dielectric material-filled spaces 10S, 110S, and 310S. In this case, the starting ends and the leading ends of the C-notch parts 42C, 142C, and 342C may each be designed to be disposed closer than the middle resonator of the any three resonators 31, 131, and 331.

However, in the third embodiment 200, the C-notch part (numeral number not illustrated in the drawing) is not specifically illustrated, but in the case of the third embodiment 200, the resonators 231 and 232 provided in the resonance substrate 230 are provided so that they extend in opposite directions from the long side of one 230A and the other long side 230B of the resonance frame 230F, respectively, but their leading ends overlap each other along the signal transmission path described above.

Hereinafter, the filter for a communication device according to embodiments of the present disclosure will be described in detail with reference to the attached drawings. However, it should be taken for granted that the embodiments of the present disclosure are not necessarily limited by the above-described embodiments, and various modifications and implementation within the equivalent range are possible by those skilled in the art to which the present disclosure belongs. Therefore, it will be said that the true scope of the present disclosure is determined by the claims described later.

### INDUSTRIAL APPLICABILITY

The present disclosure provides a filter for a communication device that includes a tuning panel having a plurality of tuning bars disposed as a single layer in a thickness direction within a dielectric material-filled space, and can perform frequency tuning by adjusting a separation distance between a plurality of resonators of a resonance substrate disposed as a single layer different from the tuning panel in the thickness direction within the dielectric material-filled space, and includes a notch forming part formed as the same single layer as the tuning panel.

1. A filter for a communication device, comprising:
a frequency tuning panel which includes a plurality of tuning bars disposed as a single layer in a thickness direction within a dielectric material-filled space to adjust a separation distance between a plurality of resonators disposed within the dielectric material-filled space.

2. The filter of claim 1, wherein the dielectric material-filled space is a closed space having a thickness smaller than a length direction and a width direction.

3. The filter of claim 1, wherein the frequency tuning panel includes:
a tuning frame having a rectangular edge; and
the plurality of tuning bars extending from an inner side of one long side to the other long side among four sides of the tuning frame.

4. The filter of claim 3, wherein the plurality of tuning bars are formed integrally with the tuning frame.

5. The filter of claim 3, wherein the plurality of tuning bars are disposed to be spaced apart from each other by a predetermined distance in the length direction.

6. The filter of claim 3, wherein the plurality of tuning bars are disposed to be spaced apart from each other in a length direction at positions that match each of the plurality of resonators disposed to be spaced apart from each other in the thickness direction within the dielectric material-filled space.

7. The filter of claim 3, wherein each of the plurality of tuning bars has different lengths extending to the other long side.

8. The filter of claim 3, wherein the frequency tuning panel further includes:
a notch forming part extending to protrude from an inner side of the other long side to the one long side among the four sides of the tuning frame while forming a closed loop, or extending to be connected to the inner side of the one long side without forming the closed loop.

9. The filter of claim 8, wherein the notch forming part includes:
an L-notch part forming the closed loop; and
a C-notch part not forming the closed loop.

10. The filter of claim 9, wherein the L-notch part implements cross coupling through magnetic field properties between any three adjacent resonators within the dielectric material-filled space.

11. The filter of claim 9, wherein the C-notch part implements cross coupling through electric field properties between any three adjacent resonators within the dielectric material-filled space.

12. The filter of claim 1, further comprising a resonance substrate that includes a resonance frame disposed as a single layer in the thickness direction within the dielectric material-filled space and has a rectangular edge, wherein the plurality of resonators are formed as the single layer.

13. The filter of claim 12, wherein the plurality of resonators are formed to extend from one long side to the other long side among the four sides of the resonance frame by a predetermined length, and disposed to overlap the plurality of tuning bars by at least a predetermined length in the thickness direction.

14. The filter of claim 13, wherein the plurality of resonators extend to be spaced apart from the other long side.

15. The filter of claim 12, further comprising a spacer panel that is disposed to be stacked in the thickness direction within the dielectric material-filled space between the frequency tuning panel and the resonance substrate to block direct contact between the frequency tuning panel and the resonance substrate.

16. The filter of claim 15, wherein the spacer panel is formed to correspond to shapes of the edges of the tuning frame of the frequency tuning panel and the resonance frame of the resonance substrate.

17. The filter of claim 12, wherein the frequency tuning panel includes a tuning frame having a thickness greater than the plurality of tuning bars, and
the resonance substrate includes a resonance frame having a thickness greater than the plurality of resonators.

18. The filter of claim 12, further comprising:
a filter body that is formed to be opened on one side of the dielectric material-filled space in the thickness direction, forms a portion of the dielectric material-filled space, and has an installation space having the resonance substrate and the frequency tuning panel stacked therein; and
a filter tuning cover that forms the rest of the dielectric material-filled space while covering the opened one side of the filter body in the thickness direction.

19. The filter of claim 18, wherein a plurality of space dividing ribs are integrally formed on an inner side surface of the filter body in the thickness direction to divide a portion of the dielectric material-filled space and protrude to divide between the plurality of resonators of the resonance substrate.

20. The filter of claim 18, wherein the filter tuning cover is formed with a plurality of tuning holes to push the plurality of tuning bars using a predetermined tool.

21. The filter of claim 18, wherein the filter tuning cover is formed with a plurality of coupling control bars cut to change a coupling value between adjacent resonators among the plurality of resonators by changing its shape toward the dielectric material-filled space.

22. The filter of claim 20, wherein the plurality of coupling control bars are alternately disposed with the plurality of resonators in the thickness direction of the dielectric material-filled space.
